(19) United States
(12) Patent Application Publication
(10) Pub. No.: US 2008/0174697 A1
(43) Pub. Date: Jul. 24, 2008

(54) APPARATUS OF PROCESSING IMAGE SECTIONS AND CONTROL METHOD THEREOF

(75) Inventor: Seong-won Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/849,650

(22) Filed: Sep. 4, 2007

(30) Foreign Application Priority Data
Jan. 23, 2007 (KR) 2007-6870

(51) Int. Cl. H04N 5/445

(52) U.S. Cl. 348/568

(57) ABSTRACT

An apparatus to process image sections and a control method thereof to include an image processing apparatus to divide an image frame into a plurality of image sections, and to transmit the divided image sections at different transmission rates. Additionally, the image processing apparatus receives the image sections at different transmission rates, and generates an image frame based on the received image sections. Accordingly, the image frame is divided into the plurality of image sections and the transmission rates may be different for each image section, and thus it is possible to transmit the image in real time. In addition, the image section is transmitted to reduce the transmission size, and therefore the compression ratio of the specific image section can be lowered to play back the high-resolution image.

### CROSS-REFERENCE TO RELATED APPLICATIONS

This application claims priority under 35 U.S.C. §119 (a) of Korean Patent Application No. 10-2007-0006870, filed on Jan. 23, 2007, in the Korean Intellectual Property Office, the disclosure of which is incorporated herein by reference in its entirety.

### BACKGROUND OF THE INVENTION

1. Field of the Invention

The present general inventive concept relates to an image processing apparatus and a control method thereof. More particularly, the present general inventive concept relates to an image processing apparatus and a control method thereof, in which an image comprising a plurality of image sections is processed for each image section.

2. Description of the Related Art

Security equipment, such as closed circuit televisions (CCTVs), has become widely used in order to reduce burglaries, accidents or the like in places such as automatic teller machines (ATMs), automatic vending machines (AVM), factories, house, or other places requiring defense and security management.

Additionally, in security equipment, photographing devices to photograph images, image recording devices to store the photographed images or display devices to display the photographed images are spatially separated from each other. Accordingly, photographing devices compress the photographed images to transmit the compressed images to image recording devices or display devices via a cable or wirelessly.

If a photographing device transmits a high-resolution image having a large capacity, the transmission speed may be lowered, and thus the problem arises that it is impossible for a user to check the photographed image in real time. Accordingly, in order to check the photographed image in real time, the photographed image is compressed with a high compression ratio in order to reduce the transmission size, but this causes deterioration in the image quality.

### SUMMARY OF THE INVENTION

The present general inventive concept provides an image processing apparatus and a control method thereof, in which an image frame can be divided into a plurality of image sections to be transmitted at different transmission rates.

The present general inventive concept also provides an image processing apparatus and a control method thereof, in which an image frame can be generated if image sections corresponding to a portion of the image frame are received.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image processing apparatus including a section divider to divide an image frame into a plurality of image sections, and a transmitter to transmit at least two image sections from among the plurality of image sections to an external device at different transmission rates.

The apparatus may further include a compressor to compress the plurality of the divided image sections. The compressor may compress at least two image sections from among the plurality of the divided image sections at different compression ratios.

The compressor may compress an image section with a high transmission rate at a lower compression ratio than an image section with a low transmission rate.

The apparatus may further include a section information generator to generate section information comprising at least one of shape information, coordinate information, layer information, index information, scaling information, transmission rate information and compression ratio information relating to the image sections.

The transmitter may transmit at least one of a section comprising a motion image and a section comprising an object image at a higher transmission rate than a section comprising a background image.

The foregoing and/or other aspects and utilities of the present general inventive concept may be achieved by providing an image processing apparatus including a receiver to receive section information and a plurality of image sections, wherein at least two image sections from among the plurality of image sections are received at different transmission rates, and an image frame generator to generate a single image frame, based on the section information and the received image sections.

The image frame generator may generate a single image frame using the received image sections and a previously received image section, if the receiver receives the image section corresponding to a portion of the image frame.

The section information may include at least one of shape information, coordinate information, layer information, index information, scaling information, transmission rate information, and compression ratio information relating to the received image sections.

The foregoing and/or other aspects and utilities of the present general inventive concept may also be achieved by providing an image processing method including dividing an image frame into a plurality of image sections, and transmitting at least two image sections from among the plurality of image sections to an external device at different transmission rates.

The method may further include compressing at least two image sections from among the plurality of the divided image sections at different compression ratios.

An image section with a high transmission rate may be compressed at a lower compression ratio than an image section with a low transmission rate.

The method may further include generating section information comprising at least one of shape information, coordinate information, layer information, index information, scaling information, transmission rate information and compression ratio information relating to the image sections.

The transmitting may include transmitting at least one of a section comprising a motion image and a section comprising an object image at a higher transmission rate than a section comprising a background image.

The foregoing and/or other aspects and utilities of the present general inventive concept may also be achieved by providing an image processing method including receiving section information and a plurality of image sections, wherein at least two image sections from among the plurality of image sections are received at different transmission rates; and generating a single image frame based on the section information and the received image sections.

The generating may include generating a single image frame using the received image sections and a previously received image section, if the image section corresponding to a portion of the image frame is received.

The section information may include at least one of shape information, coordinate information, layer information, index information, scaling information, transmission rate information, and compression ratio information relating to the received image sections.

The foregoing and/or other aspects and utilities of the present general inventive concept may also be achieved by providing an image processing system including a first image processing apparatus to divide an image frame into a plurality of image sections, and to transmit at least two image sections from among the plurality of image sections to an external device at different transmission rates, and a second image processing apparatus to receive section information and the plurality of image sections, and to generate a single frame image frame, based on the section information and the received at least two image sections

The foregoing and/or other aspects and utilities of the present general inventive concept may also be achieved by providing an image processing method including dividing an image frame into a plurality of image sections, and transmitting at least two image sections from among the plurality of image sections to an external device at different transmission rates; and receiving section information and the transmitted image sections, and generating a single frame image frame, based on the section information and the received image sections.

The foregoing and/or other aspects and utilities of the present general inventive concept may also be achieved by providing an image processing apparatus including a compressor to compress a first image section of an image frame at a first compression ratio and a second image section of the image frame at a second compression ratio.

The apparatus may further include a transmitter to transmit a first compressed image section of an image frame at a first transmission rate and a second compressed image section of the image frame at a second transmission rate.

The image processing apparatus may include a compressor to compress a first image section of an image frame at a first compression ratio and a second image section of the image frame at a second compression ratio, and a transmitter to transmit the first compressed image section of the image frame at a first transmission rate and the second compressed image section of the image frame at a second transmission rate.

The foregoing and/or other aspects and utilities of the present general inventive concept may also be achieved by providing section divider to divide an image frame into a plurality of image sections, a compressor to compress the first image section of the image frame at a first compression ratio and the second image section of the image frame at a second compression ratio; and a transmitter to transmit the first compressed image section of the image frame at a first transmission rate and the second compressed image section of the image frame at a second transmission rate.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a photographing device employed in an exemplary embodiment of the present general inventive concept;

FIG. 2 is a block diagram illustrating a display device employed in an exemplary embodiment of the present general inventive concept;

FIG. 3 is a flowchart providing a method of dividing and compressing an image frame so that the image may be transmitted, according to an exemplary embodiment of the present general inventive concept;

FIG. 4 is a flowchart providing a method of receiving section information and image to generate and display an image frame, according to an exemplary embodiment of the present general inventive concept; and

FIGS. 5A to 5C are views providing in detail the flowcharts of FIGS. 3 and 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

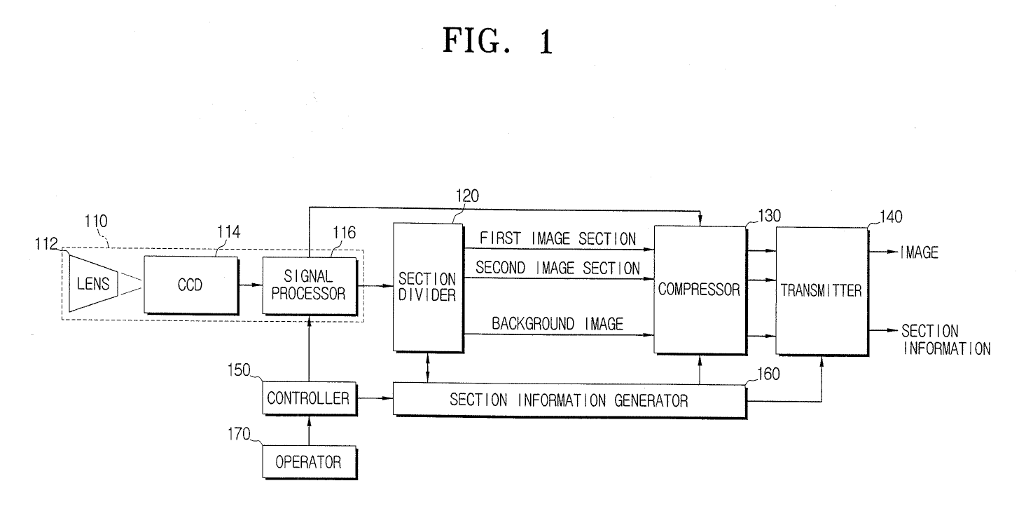

An image processing apparatus may be divided into a photographing device serving as a transmitter, and a display device serving as a receiver. FIG. 1 is a block diagram illustrating a photographing device employed in an exemplary embodiment of the present general inventive concept. In FIG. 1, the photographing device includes an image capture part 110, a section divider 120, a compressor 130, a transmitter 140, a section information generator 160, an operator 170, and a controller 150.

The image capture part 110 may include a lens 112, a charge-coupled device (CCD) 114, and a signal processor 116.

The CCD 114 is an image sensor to capture an optical image of a subject inserted through the lens 112 and to generate an image corresponding to the captured image. The photographing device can also be implemented using a complementary metal oxide semiconductor (CMOS) image sensor instead of the CCD 114 to capture the optical image to generate the image corresponding to the captured image.

The signal processor 116 can process the image, for example, remove noise, adjust a signal level, convert an analog signal into a digital signal, and perform digital signal processing (DSP) for the image output from the CCD 114.

The section divider 120 can divide an image frame of the image into a plurality of image sections. For convenience of description, it is assumed that the image frame is divided into three image sections, and three image sections are individually referred to as a first image section having a first image, a second image section having a second image, and a background image section having a background image. The section divider 120 can output the divided image sections to the compressor 130. A signal representing the image may include frames in a time axis. Each of the frames may be an image frame.

The compressor 130 can compress each of the plurality of image sections output from the section divider 120 into a predetermined format. The compressor 130 can compress the image sections using different compression methods for each image section. In other words, the first and second image sections may be compressed using a Joint Photographic Experts Group (JPEG) compression method at low compression ratios, and the background image section may be compressed using a Moving Picture Experts Group (MPEG) compression method at a high compression ratio.

The transmitter 140 can transmit the compressed image sections at different transmission rates. For example, the transmission rate of the first image section may be approximately 30 times per second, the transmission rate of the second image section may be approximately 20 times per second, and the transmission rate of the background image section may be approximately 10 times per second.

The controller 150 can control the entire operation of the photographing device. Specifically, if a user inputs a command to divide the image frame into image sections through the operator 170, the controller 150 can control the signal processor 116 to apply the image processed by the signal processor 116 to the section divider 120. Additionally, the controller 150 can control the section information generator 160 to generate section information, i.e., information on the divided image sections.

The section information generator 160 can generate the section information. The section information, herein, may refer to information required to divide the image frame into the plurality of image sections, and also to information required to combine the plurality of image sections. The section information may include one or more characteristics of the image sections to generate or restore the image frame.

The section information may include image section position information on the image frame, image section processing information, and index information to link the image sections with the position information and image processing information. Additionally, the image section position information on the image frame may include section coordinate information, shape information, and layer information when overlapping the image sections. The image section processing information may include compression ratio information for the image sections, transmission rate information for the image sections, scaling information for the image sections, or other information.

If the user inputs the command to divide the image frame into the plurality of image sections through the operator 170, the section information generator 160 can automatically generate the image section position information and index information in response to the command. However, the section information generator 160 can generate the image section processing information only when the user inputs a separate operation command, or the image section processing information can be automatically generated for each important image section.

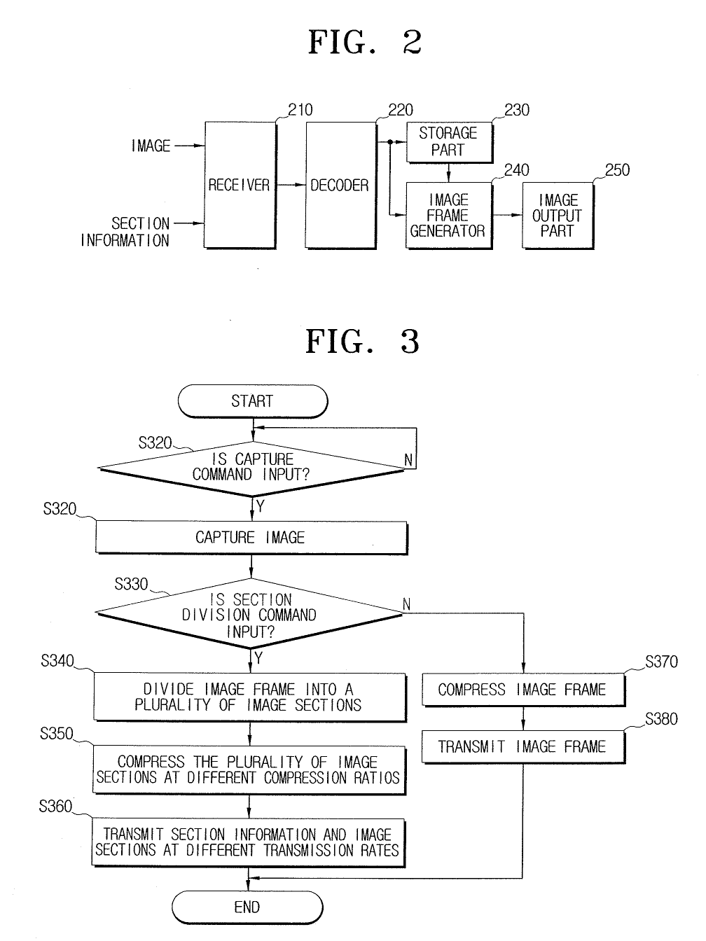

FIG. 2 is a block diagram illustrating a display device employed in an exemplary embodiment of the present general inventive concept. As illustrated in FIG. 2, the display device includes a receiver 210, a decoder 220, a storage part 230, an image frame generator 240, and an image output part 250.

The receiver 210 can receive the section information and image from an external device to output the received information and image to the decoder 220. The external device may be the photography device of FIG. 1, and the section information and image are transmitted from the photography device of FIG. 1 to the receiver 210 of the display device of FIG. 2. The decoder 220 can decode the image into an original signal that can be played back. The received image may be compressed using different compression methods, so the decoder 220 can decode the image section, based on their compression ratio information contained in the section information.

The storage part 230 can store the decoded image output from the decoder 220 under the control of the image frame generator 240. The image frame generator 240 can generate an image frame, based on the decoded image output from the decoder 220. Description is made below in a situation in which the decoded image output from the decoder 220 is a single image frame. If the decoded image output from the decoder 220 is the image section corresponding to a portion of the image frame, the image frame generator 240 can receive the decoded image output from the decoder 220 together with remaining image sections, which are required to generate an image frame, from the storage part 230, and then generate an image frame. The image output part 250 can display the image, and may be implemented as a liquid crystal display (LCD).

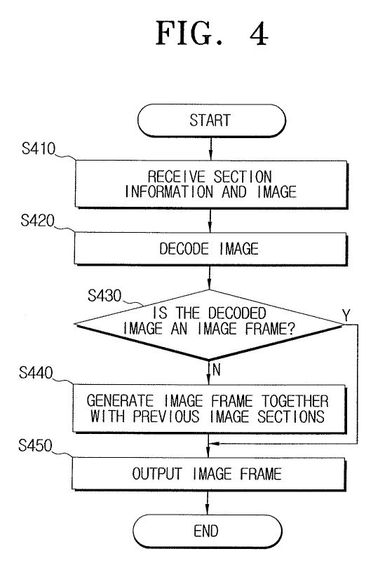

Hereinafter, a process by which the photographing device of FIG. 1 divides, compresses and transmits the photographed image will be described in detail with reference to FIG. 3. FIG. 3 is a flowchart providing a method of dividing and compressing an image frame so that the image may be transmitted, according to an exemplary embodiment of the present general inventive concept.

In FIG. 3, if a capture command is input in operation S310-Y, the image capture part 110 can capture an image in operation S320. Specifically, the CCD 114 can capture the optical image of the subject inserted through the lens 112 to output the captured image to the signal processor 116. The signal processor 116 can remove noise, convert an analog signal into a digital signal, and perform DSP for the image output from the CCD 114.

The controller 150 can determine whether the section division command is input in operation S330. Specifically, the user can input the command indicating whether the photographed image is divided into the plurality of image sections by using operator 170.

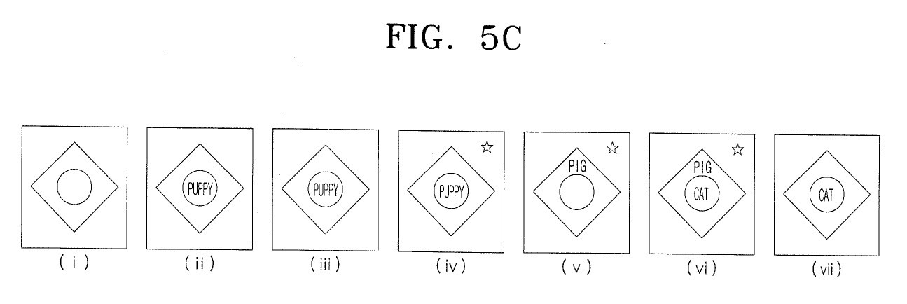

In FIG. 5(i), the user can divide the image into a section within the circle, a section between the circle and diamond, and a remaining section, which are referred to as the first section, the second section, and the background section, respectively. Additionally, the first section may be assumed to be the most important, the second section the second most important, and the background section the least important. The controller 150 can determine whether that the section division command is input.

If it is determined that the section division command is input in operation S330-Y, the section divider 120 can divide the photographed image frame into the plurality of image sections in operation S340. Specifically, the controller 150 can control the section information generator 160 to generate the section information in response to the command input through the operator 170. The section information generator 160 can generate image section position information, image processing information, and index information. Additionally, the section information generator 160 can apply the position information to the section divider 120. Accordingly, the section divider 120 can divide the image frame output from the signal processor 116 into the first image section, second image section and background image using the position information, and then apply each of the divided image sections to the compressor 130.

The compressor 130 can compress the divided image sections at different compression ratios in operation S350. Specifically, the compressor 130 can receive the image sections from the section divider 120, and receive the compression ratio information among the image processing information from the section information generator 160. If the compressor 130 receives information on the low compression ratios for the first and second image sections and information on the high compression ratio for the background image, the compressor 130 can compress the first and second image sections at low compression ratios, and compress the background image at a high compression ratio, on a basis of the set compression ratios. Next, the compressed images can be transmitted to the transmitter 140.

The transmitter 140 can transmit the section information and image sections at different transmission rates in operation S360. The transmitter 140 can transmit the image sections, according to the transmission rate information for the image sections, which is output from the section information generator 160. If the first image section is transmitted at a rate of once per 1/60 second, the second image section transmitted at a rate of once per 1/30 second, and the background image transmitted at a rate of once per 1/20 second, then the transmitter 140 can transmit the images at the above rates.

Referring to FIGS. 5A to 5C, FIG. 5A illustrates images photographed by the photographing device at an interval of 1/60 second, FIG. 5B illustrates image sections transmitted at an interval of 1/60 second, and FIG. 5C illustrates images displayed by the display device at an interval of 1/60 second. In FIG. 5A, each of the image frames can be divided into the first image section, second image section, and background image section by the section divider 120, and each of image sections can be compressed based on the compression ratios set by the compressor 130 to be output to the transmitter 140. However, the image sections transmitted from the transmitter 140 to the external device are illustrated in FIG. 5B, and image sections which are not shown in FIG. 5B can be deleted by the transmitter 140.

In FIG. 5, all of the compressed image sections of FIG. 5A(i) can be transmitted to the external device as illustrated in FIG. 5B(i). However, only the first image section of the image photographed after 1/60 second has elapsed, as illustrated in FIG. 5A(ii), can be transmitted to the external device as illustrated in FIG. 5B(ii). Accordingly, the second image section and background image section are not transmitted to the external device.

Additionally, only the first and second image sections of the image photographed after 2/60 second has elapsed, as illustrated in FIG. 5A(iii), can be transmitted to the external device as illustrated in FIG. 5B(iii). Furthermore, only the first image section and background image section of the image photographed after 3/60 second has elapsed, as illustrated in FIG. 5A(iv), can be transmitted to the external device as illustrated in FIG. 5B(iv).

Accordingly, the transmitter 140 can transmit each of the image sections to the external device, according to the set transmission rates, together with the section information. The images and section information can be transmitted to the external device via a cable or wirelessly.

If it is determined that the section division command is not input in operation S330-N, then the image output from the signal processor 116 in the image capture part 110 can be applied to the compressor 130 to be compressed in an image frame unit in operation S370. Specifically, the controller 150 can control the signal processor 116 to apply the image output from the signal processor 116 to the compressor 130. Next, the compressor 130 can compress the image frame. Additionally, the transmitter 140 can transmit the image frame to the external device in operation S380.

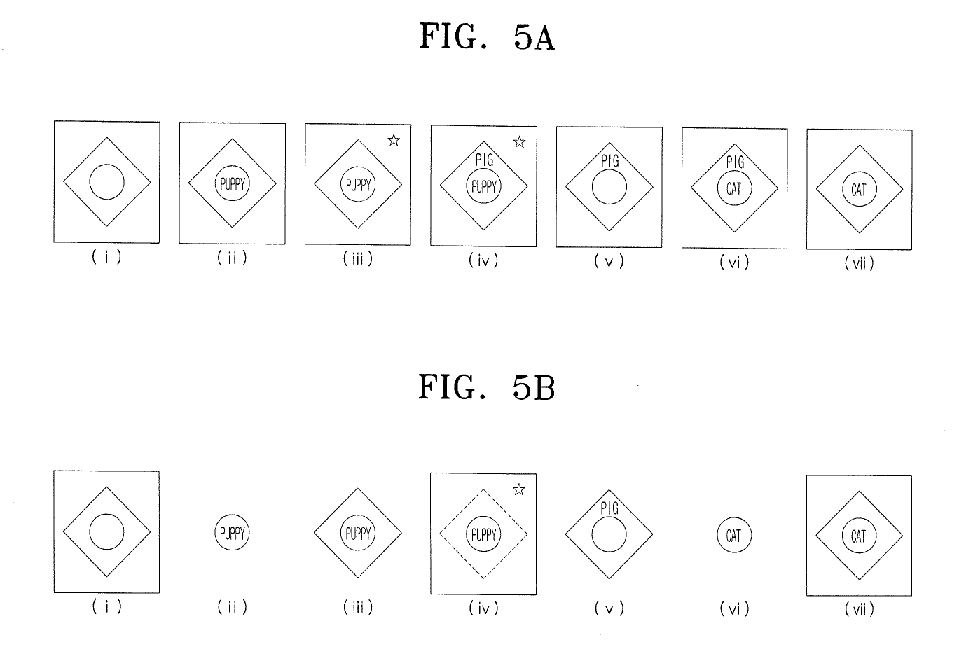

Hereinafter, a process by which the display apparatus of FIG. 2 receives and displays the image frame will be described. FIG. 4 is a flowchart explaining a method of receiving the section information and image to generate and display an image frame, according to an exemplary embodiment of the present general inventive concept.

The receiver 210 can receive the section information and image to output the received information and image to the decoder 220 in operation S410 as shown in FIG. 4. The receiver 210 can receive the section information and image from the external device via a cable or wirelessly.

The decoder 220 can decode the image output from the receiver 210 into an original signal that can be played back in operation S420. The decoder 220 can decode the image into an original signal that can be played back, using the compression ratio information contained in the section information.

The image frame generator 240 can determine whether the image decoded by the decoder 220 is a single image frame in operation S430. If the received image indicates all the image sections constitute the image frame, as shown in FIG. 5B(i), the image frame generator 240 can determine that the decoded image is the image frame. On the other hand, if the received image is the first image section, that is, a portion of the image frame, as shown in FIG. 5B(ii), the image frame generator 240 can determine that the decoded image is not the image frame.

If it is determined that the decoded image is not the image frame in operation S430-N, the image frame generator 240 can combine the received image and previously received image sections to generate a single image frame in operation S440. Specifically, if the received image is the first image section, as shown in FIG. 5B(ii), then the image frame generator 240 can read out from the decoder 220 the received first image section. However, the second image section and background image, which are shown in FIG. 5B(i) and among the previous image sections stored in the storage part 230, are required for the frame generator to generate the image frame. Thus, the image frame generator 240 can generate an image frame shown in FIG. 5C(ii), using the second image section and background image of FIG. 5B(i), and the first image section of FIG. 5B(ii).

In the same manner, if the received image from the decoder 220 comprises the first and second image sections shown in FIG. 5B(iii), then the image frame generator 240 can read out the background image of FIG. 5B(i) being stored in the storage part 230. Thus, a signal image frame shown in FIG. 5C(iii) can be generated using the first and second image sections received from the decoder 220, and the background image read from the storage part 230.

As described above, when the received image is a portion of the image frame, the image frame may be generated by using the previous image sections with the received image sections. Accordingly, the photographed image of FIG. 5A(iii) may differ from the displayed image of FIG. 5C(iii), received during the same period of time. Since the transmission rates may be different for each image section, the image received from the decoder, which is the important image section, can be received at high resolution in real time. Additionally, it is possible to check other image sections, excluding the important received image sections, in a place separate from the photographing device.

The image output part 250 can output the generated image frame in operation S450.

Although the untransmitted image sections among the compressed image sections can be deleted by the transmitter 140 in operation S360, the present general inventive concept is not limited thereto. For example, the transmission rates of the image sections can be applied when the divided image sections are output from the section divider 120 to the compressor 130. Accordingly, only the image sections to be transmitted to the external device can be output to the compressor 130 and compressed, and thus it is possible to reduce the time required to process signals in the photographing device.

For example, an image section of a star shape of FIG. 5A(iii) can be added to the image of FIG. 5B(iii) to be transmitted to the external device. The display device may decode and display the image section of the star shape to be included in the displayed image of FIG. 5C(iii). Another image section of “PIG” of FIG. 5A(iv) can be added to the image of FIG. 5B(iv) to be transmitted and to be displayed in FIG. 5C(iv).

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

In an exemplary embodiment of the present general inventive concept, the important image sections can be compressed at the low compression ratios, but the present general inventive concept is limited as follows.. For example, when information on the compression ratio is not particularly set, the image sections cannot be distinguished and are compressed at the same compression ratio to be transmitted at different transmission rates.

In the method of dividing the image frame into the image sections according to an exemplary embodiment of the present general inventive concept, division can be performed at, for example, the center of a display screen. Accordingly, a motion image and an object image can be separated from the background image.

According to an exemplary embodiment of the present general inventive concept as described above, the image frame can be divided into the plurality of image sections and the transmission rates may be different for each image section. Thus, it is possible to transmit the image in real time.

Additionally, the image sections can be transmitted to reduce the transmission size, and thus the compression ratio of the specific image section can be lowered to play back the high-resolution image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image processing apparatus comprising:
a section divider to divide an image frame into a plurality of image sections; and
a transmitter to transmit at least two image sections from among the plurality of image sections to an external device at different transmission rates.

2. The apparatus as claimed in claim 1, further comprising:
a compressor to compress the plurality of the divided image sections,
wherein the compressor compresses the at least two image sections from among the plurality of the divided image sections at different compression ratios.

3. The apparatus as claimed in claim 2, wherein:
the different transmission rates comprise a high transmission rate and a low transmission rate;
the different compression ratios comprise a high compression ratio and a low compression ratio; and
the compressor compresses one of the two image sections with the high transmission rate at a lower compression ratio than the other one of the two image sections with the low transmission rate at one of the high and the low compression ratios.

4. The apparatus as claimed in claim 1, further comprising:
a section information generator to generate section information comprising at least one of shape information, coordinate information, layer information, index information, scaling information, transmission rate information and compression ratio information relating to the image sections.

5. The apparatus as claimed in claim 1, wherein:
each of the plurality of image sections comprise at least one of a section comprising a motion image, a section comprising an object image, and a section comprising a background image; and
the transmitter transmits the one of the sections comprising the motion image, the object image, and the background image.

6. An image processing apparatus comprising:
a receiver to receive section information and a plurality of image sections, wherein at least two image sections from among the plurality of image sections are received at different transmission rates; and
an image frame generator to generate a single image frame, based on the section information and the received at least two image sections.

7. The apparatus as claimed in claim 6, wherein the image frame generator generates the single image frame using the received image sections and a previously received image section, if the receiver receives the image section corresponding to a portion of the single image frame.

8. The apparatus as claimed in claim 6, wherein the section information comprises at least one of shape information, coordinate information, layer information, index information, scaling information, transmission rate information, and compression ratio information relating to the received image sections.

9. An image processing method comprising:
dividing an image frame into a plurality of image sections; and
transmitting at least two image sections from among the plurality of image sections to an external device at different transmission rates.

10. The method as claimed in claim 9, further comprising compressing at least two image sections from among the plurality of the divided image sections at different compression ratios.

11. The method as claimed in claim 10, wherein an image section with a high transmission rate is compressed at a lower compression ratio than an image section with a low transmission rate.

12. The method as claimed in claim 9, further comprising generating section information comprising at least one of shape information, coordinate information, layer information, index information, scaling information, transmission rate information and compression ratio information relating to the image sections.

13. The method as claimed in claim 9, wherein the transmitting comprises transmitting at least one of a section comprising a motion image and a section comprising an object image at a higher transmission rate than a section comprising a background image.

14. An image processing method comprising:
receiving section information and a plurality of image sections, wherein at least two image sections from among the plurality of image sections are received at different transmission rates; and
generating a single image frame based on the section information and the received image sections.

15. The method as claimed in claim 14, wherein the generating comprises generating a single image frame using the received image sections and a previously received image section, if one of the image sections corresponding to a portion of the single image frame is received.

16. The method as claimed in claim 14, wherein the section information comprises at least one of shape information, coordinate information, layer information, index information, scaling information, transmission rate information, and compression ratio information relating to the received image sections.

17. An image processing system comprising:
a first image processing apparatus to divide an image frame into a plurality of image sections, and to transmit at least two image sections from among the plurality of image sections to an external device at different transmission rates; and
a second image processing apparatus to receive section information and the transmitted image sections, and to generate a single frame image frame, based on the section information and the received two image sections.

18. An image processing method comprising:
dividing an image frame into a plurality of image sections, and transmitting at least two image sections from among the plurality of image sections to an external device at different transmission rates; and
receiving section information and the transmitted image sections, and generating a single frame image frame, based on the section information and the received image sections.

19. An image processing apparatus comprising:
a compressor to compress a first image section of an image frame at a first compression ratio and a second image section of the image frame at a second compression ratio; and
a transmitter to transmit the first compressed image section of the image frame at a first transmission rate and the second compressed image section of the image frame at a second transmission rate.

20. An image processing apparatus comprising:
a section divider to divide an image frame into a plurality of image sections;
a compressor to compress the first image section of the image frame at a first compression ratio and the second image section of the image frame at a second compression ratio; and
a transmitter to transmit the first compressed image section of the image frame at a first transmission rate and the second compressed image section of the image frame at a second transmission rate.
